(19) United States
(12) Patent Application Publication
(10) Pub. No.: US 2021/0097941 A1
(43) Pub. Date: Apr. 1, 2021

(54) CONTROL APPARATUS AND CONTROL METHOD FOR CONTROLLING DISPLAY APPARATUS HAVING LIGHT-EMITTING MODULE AND DISPLAY PANEL

(71) Applicant: CANON KABUSHIKI KAISHA, Tokyo (JP)

(72) Inventors: Masatsugu Sasaki, Kanagawa (JP); Mitsuru Tada, Tokyo (JP)

(21) Appl. No.: 17/036,830

(22) Filed: Sep. 29, 2020

(30) Foreign Application Priority Data
Oct. 1, 2019 (JP) 2019-181450

(51) Int. Cl. G09G 3/34; G09G 3/36

(52) U.S. Cl. CPC G09G 3/342; G09G 3/36; G09G 2320/0271; G09G 2360/141; G09G 2320/0646; G09G 2360/145; G09G 2320/0693

(57) ABSTRACT

A control apparatus controls a display apparatus including a light-emitting module and a display panel configured to display an image based on image data on a display surface by modulating light emitted from the light-emitting module. The control apparatus includes at least one memory containing instructions and at least one processor which, by executing the instructions, functions as a control unit configured to control the display apparatus so that a patch image for calibration of the display apparatus is displayed on the display surface. In a case where an emission brightness of the light-emitting module is controlled in accordance with the image data, the control unit controls the display apparatus so that a patch image that is smaller than the display surface is displayed on the display surface.

### BACKGROUND

### Technical Field

One disclosed aspect of the embodiments relates to a control apparatus for controlling a display apparatus and a control method thereof.

### Description of the Related Art

In recent years the high dynamic range (HDR) standard was established, and display in a wide dynamic range (brightness range) from 0.001 nit (a standard unit of luminance) to 1,000 nit or higher brightness is often demanded for display apparatuses in order to conform to the HDR standard. A known liquid crystal display apparatus that conforms to the HDR standard is a liquid crystal display apparatus that performs local dimming (LD) control, which individually controls the emission brightness of each region (each light source) of the backlight module in accordance with the image data.

Brightness and color reproducibility change in a display apparatus due to age deterioration and temperature change. Therefore in order to implement stable and constant reproducibility, the display apparatus must be calibrated periodically.

To perform calibration, a patch image is displayed on the display surface of the display apparatus, and the light from the display region of the patch image is measured using a photometer. Then calibration is performed using the acquired measured values (values measured by the photometer). Specifically, in the case of calibration, parameters, to correct the brightness, color gamut, color temperature, gamma and the like of the display apparatus, to become close to the ideal values (target values), are determined based on the measured values.

If the temperature changes in the display region of a patch image, inappropriate measured values (inaccurate measured values; unstable measured values) may be acquired, and calibration may be performed using these inappropriate measured values. In such a case, after the calibration, a desired display may not be performed, and the measured values of the photometer may deviate from the ideal values considerably. For example, even if the parameters determined by calibration are used after the temperature of the display region of the patch image is stabilized, the display brightness and display colors of the patch image may not become the desired brightness and colors. In the state where LD control is ON, the emission brightness distribution (emission brightness of each light source) of the backlight module changes in accordance with the change of the image data, hence a major temperature change of the liquid crystal display apparatus tends to be generated, and inappropriate measured values are sometimes acquired.

Japanese Patent Application Publication No. 2012-208472 discloses a technique to display a patch image in a region of which temperature difference from a reference temperature is smaller than a threshold in the case where calibration is executed immediately after the LD control ends and LD control turns OFF. Further, Japanese Patent Application Publication No. 2013-008000 discloses a technique to perform calibration when LD control is ON in the case where the contrast specified by the user is not satisfied.

In the case where the emission brightness of a light-emitting unit, such as a backlight module, is controlled in accordance with the image data, the emission brightness of the light-emitting unit changes because of the change in gradation values of the patch image, and the temperature of the display apparatus changes accordingly. However, in the techniques disclosed in Japanese Patent Application Publication No. 2012-208472 and No. 2013-008000, the temperature change caused by the change in the gradation values of the patch image is not considered. Therefore accurate calibration cannot be performed in the case of controlling the emission brightness of the light-emitting unit in accordance with the image data.

### SUMMARY

One embodiment provides a technique to perform highly accurate calibration, even in the case of controlling the emission brightness of the light-emitting unit in accordance with the image data.

The disclosure in its first aspect provides a control apparatus for controlling a display apparatus including a light-emitting module and a display panel configured to display an image based on image data on a display surface by modulating light emitted from the light-emitting module. The control apparatus includes at least one memory containing instructions and at least one processor which, by executing the instructions, functions as:

a control unit configured to control the display apparatus so that a patch image for calibration of the display apparatus is displayed on the display surface,

wherein in a case where an emission brightness of the light-emitting module is controlled in accordance with the image data, the control unit controls the display apparatus so that a patch image that is smaller than the display surface is displayed on the display surface.

The disclosure in its second aspect provides a display apparatus including a light-emitting module and a display panel configured to display an image based on image data on a display surface by modulating light emitted from the light-emitting module. The display apparatus includes at least one memory containing instructions and at least one processor which, by executing the instructions, functions as:

a control unit configured to control the display apparatus so that a patch image for calibration of the display apparatus is displayed on the display surface,

wherein in a case where an emission brightness of the light-emitting module is controlled in accordance with the image data, the control unit controls the display apparatus so that a patch image that is smaller than the display surface is displayed on the display surface.

The disclosure in its third aspect provides a control method for controlling a display apparatus including a light-emitting module and a display panel configured to display an image based on image data on a display surface by modulating light emitted from the light-emitting module. The control method includes:

acquiring the image data; and

controlling the display apparatus so that a patch image for calibration of the display apparatus is displayed on the display surface,

wherein in a case where an emission brightness of the light-emitting module is controlled in accordance with the image data, in the controlling, the display apparatus is controlled so that a patch image that is smaller than the display surface is displayed on the display surface.

The disclosure in its fourth aspect provides a non-transitory computer readable medium that stores a program, wherein the program causes a computer to execute a control method for controlling a display apparatus including a light-emitting module and a display panel configured to display an image based on image data on a display surface by modulating light emitted from the light-emitting module. The control method includes:

acquiring the image data; and

controlling the display apparatus so that a patch image for calibration of the display apparatus is displayed on the display surface,

wherein in a case where an emission brightness of the light-emitting module is controlled in accordance with the image data, in the controlling, the display apparatus is controlled so that a patch image that is smaller than the display surface is displayed on the display surface.

Further features of the disclosure will become apparent from the following description of exemplary embodiments with reference to the attached drawings.

### BRIEF DESCRIPTION OF THE DRAWINGS

FIG. 1 is a block diagram depicting a configuration example of a display apparatus according to Embodiment 1.

FIG. 2 is a table indicating an example of an action list according to Embodiment 1.

FIG. 3 is a flow chart depicting an example of a processing flow according to Embodiment 1.

FIG. 4 is a diagram depicting an operation example according to a comparative example.

FIG. 5 is a diagram depicting an operation example according to Embodiment 1.

FIG. 6 is a table indicating an example of an action list according to Embodiment 2.

FIG. 7 is a block diagram depicting a configuration example of a display apparatus and a control apparatus according to a modification.

### DESCRIPTION OF THE EMBODIMENTS

### Embodiment 1

Embodiment 1 of the disclosure will be described. In Embodiment 1, an example of a transmissive type liquid crystal display apparatus, which can perform local dimming (LD) control by individually controlling the emission brightness of each light source of the backlight module (light-emitting module) in accordance with the image data, will be described. In concrete terms, in Embodiment 1, when the LD control is performed, the size of the patch image for calibrating the display apparatus (liquid crystal display apparatus) is made smaller than the display surface (surface on which an image is displayed) of the liquid crystal panel. Thereby even if the LD control is performed, the temperature change in the region where the patch image is displayed (temperature change caused by the changes of the gradation values of the patch image) is decreased, and highly accurate calibration can be implemented. If the display apparatus includes a light-emitting unit and a display unit, which modulates light emitted from the light-emitting unit and displays an image based on the image data on the display surface, and can control the emission brightness of the light-emitting unit in accordance with the image data, then the display apparatus used here is not especially limited. For example, the display apparatus may be a reflective type liquid crystal display apparatus. The display apparatus may be a micro electro mechanical system (MEMS) shutter type display apparatus, which uses MEMS shutters instead of the liquid crystal elements.

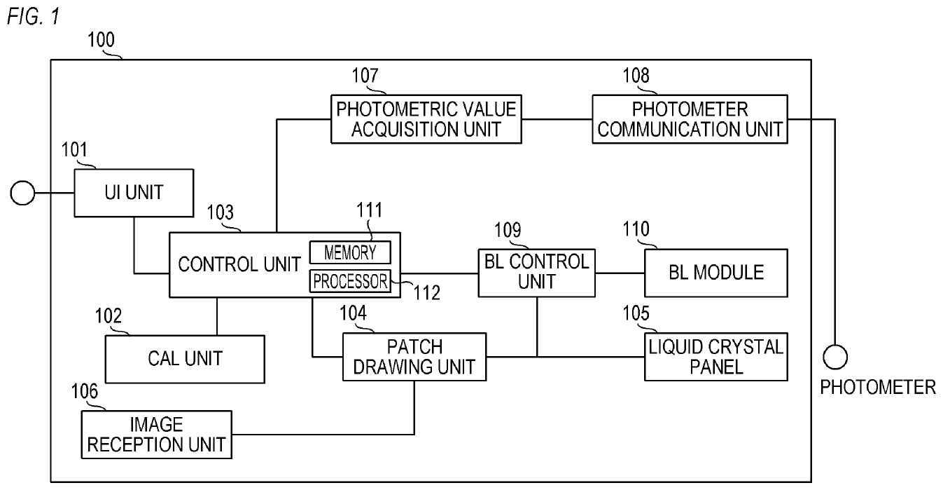

FIG. 1 is a block diagram depicting a configuration example of the display apparatus (transmissive type liquid crystal display apparatus) 100 according to Embodiment 1. The display apparatus 100 includes a user interface (UI) unit 101, a calibration (CAL) unit 102, a control unit 103, a patch drawing unit 104, a liquid crystal panel 105, an image reception unit 106, a photometric value acquisition unit 107, a photometer communication unit 108, a backlight (BL) control unit 109 and a BL module 110.

The UI unit 101 is an operation unit that receives a user operation (operation from the user), and outputs a signal in accordance with the performed user operation to the control unit 103. Examples of the user operation are: an operation to specify the target values of calibration, an operation to specify a photometer used for calibration, and an operation to instruct the start of calibration (calibration start operation).

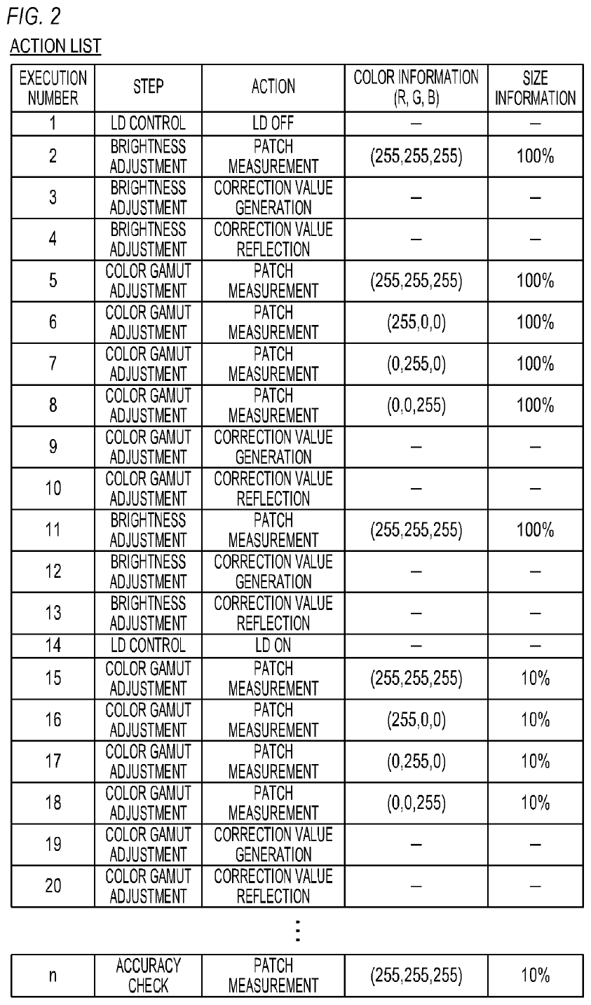

In the CAL unit 102, a calibration execution table (action list), as indicated in FIG. 2, is stored in advance. When a next processing acquisition request is received from the control unit 103, the CAL unit 102 replies with the information on the action defined in the action list to the control unit 103. For example, in the action list, an execution number of the action, the processing step corresponding to the action, and a name of the action are defined, so as to correspond with each other. Each time the next processing acquisition request is received from the control unit 103, the CAL unit 102 notifies the action to the control unit 103, so that the actions are notified to the control unit 103 sequentially from the action with the execution number 1. In the action list indicated in Embodiment 1 (FIG. 2), it is assumed that a patch image, of which size is different between the LD control ON state (state where LD control is performed) and the LD control OFF state (state where LD control is not performed), is displayed on the display surface of the liquid crystal panel 105.

Further, when a correction value generation request is received from the control unit 103, the CAL unit 102 generates a correction value based on the target value of the calibration and the photometric value (measured value of the light emitted from the region where the patch image is displayed on the display screen). Furthermore, when a correction value acquisition request is received from the control unit 103, the CAL unit 102 outputs a correction value, which was generated in accordance with the reception of the correction value generation request, to the control unit 103.

The control unit 103 controls the display apparatus 100 in general. In a typical configuration, the control unit 103 includes at least a memory 111 and at least a processor 112. The memory 111 contains a program or instructions. The processor 112 is a programmable device, a processor, or a central processing unit (CPU) that, by executing the program or instructions in the memory 111, functions as the various units as described in the following. For example, when a signal in accordance with the calibration start operation is received from the UI unit 101, the control unit 103 outputs the target value of the calibration and the calibration start request to the CAL unit 102. Further, the control unit 103 outputs the next processing acquisition request to the CAL unit 102, acquires the information on the action to be executed next from the CAL unit 102, and performs the operation as follows in accordance with the acquired information (action).

In the case where the action is a “patch measurement”, the control unit 103 outputs the color information and size information, which are acquired from the CAL unit 102, to the patch drawing unit 104, and outputs a patch drawing request to the patch drawing unit 104. After the patch image is displayed, the control unit 103 outputs a photometric value acquisition request to the photometric value acquisition unit 107, and acquires the photometric value of the displayed patch image from the photometric value acquisition unit 107. When the photometric value acquisition request is outputted, the control unit 103 also outputs the information on the photometer to be used (photometer information) to the photometric value acquisition unit 107.

In the case when the action is “correction value generation”, the control unit 103 outputs a correction value generation request to the CAL unit 102. When the correction value generation request is outputted, the control unit 103 also outputs the photometric value acquired from the photometric value acquisition unit 107 to the CAL unit 102.

In the case where the action is “correction value reflection”, the control unit 103 outputs the correction value acquisition request to the CAL unit 102, and acquires the correction value, generated by the CAL unit 102, from the CAL unit 102.

Then the control unit 103 updates a parameter (e.g. gain value, offset value) of the display apparatus 100 using the acquired correction value, whereby the parameter correction (parameter determination) is performed based on the calibration. For example, parameters to correct the brightness, color gamut, color temperature, gamma or the like of the display apparatus 100 is corrected (determined) by the calibration. In concrete terms, a parameter to correct the transmittance of the liquid crystal panel 105, a parameter to correct the emission brightness of the BL module 110, a parameter to correct the gradation value of the image data or the like is corrected (determined).

In the case where the action is “LD control switching (LD OFF/LD ON)”, the control unit 103 outputs an LD control switching request to the BL control unit 109. In concrete terms, when the action is “LD OFF”, the control unit 103 outputs the LD control switching request to the BL control unit 109 so that the execution state of the LD control becomes OFF. When the action is “LD ON”, on the other hand, the control unit 103 outputs the LD control switching request to the BL control unit 109, so that the execution state of the LD control becomes ON.

When a patch drawing request is received from the control unit 103, the patch drawing unit 104 generates patch image data (image data where a patch image is drawn or disposed) based on the color information and size information which were received together with the patch drawing request. In concrete terms, image data where a patch image, which has gradation values (pixel values, such as RGB—Red value, Green value, Blue value—values) indicated in the color information and size indicated in the size information, is drawn and generated as the patch image data. The method of generating the patch image data is not especially limited, but in Embodiment 1, the patch image data is generated so that the area around the patch image is displayed to be darker than the patch image. Specifically, the patch image data is generated such that the patch image is displayed at the center of the black image (minimum gradation value: 0). Then the patch drawing unit 104 outputs the generated patch image data to the liquid crystal panel 105 and the BL control unit 109. If the patch drawing request is not outputted from the control unit 103, the patch drawing unit 104 outputs the image data outputted from the image reception unit 106 to the liquid crystal panel 105 and the BL control unit 109.

The liquid crystal panel 105 is a display unit that transmits (modulates) the light emitted from the BL module 110, and displays an image, that is generated based on the image data received from the patch drawing unit 104, on the display surface. In concrete terms, the liquid crystal panel 105 transmits light emitted from the BL module 110 with the transmittance distribution based on the image data received from the patch drawing unit 104. If the patch image data is outputted from the patch drawing unit 104, the patch image is displayed on the display surface.

The image reception unit 106 receives image data which is inputted from outside the display apparatus 100, and outputs the received image data to the patch drawing unit 104.

When a photometric value acquisition request is received from the control unit 103, the photometric value acquisition unit 107 outputs the photometric value acquisition request to the photometer communication unit 108, acquires the photometric value from the photometer communication unit 108, and outputs the acquired photometric value to the control unit 103. When the photometric value acquisition request is outputted, the control unit 103 also outputs the photometer information, which was received together with the photometric value acquisition request, to the photometer communication unit 108.

When the photometric value acquisition request is received from the photometric value acquisition unit 107, the photometer communication unit 108 outputs a photometry instruction (measurement instruction) to a photometer indicated by the photometer information which was received with the photometric value acquisition request. The photometer performs photometry (measurement of light) in accordance with the photometry instruction. Then the photometer communication unit 108 acquires the photometry result (photometric value), from the photometer, and outputs the acquired photometric value to the photometric value acquisition unit 107. The photometer communication unit 108 may detect the photometer connected to the display apparatus 100 without using the photometer information, output the photometry instruction to the detected photometer, and acquire the photometric value from the detected photometer. The photometer may be a part of the display apparatus 100. Photometry may be the measurement of the brightness of the light (display brightness or brightness on the display surface) or the measurement of the color of the light (display color or color on the display surface), or may be the measurement of both the brightness and color of the light. The photometric value may be a value indicting the brightness of the light, or a value indicating the color of the light, or a value indicating both the brightness and color of the light.

The BL control unit 109 controls the emission brightness of the BL module 110. The BL control unit 109 can control the emission brightness of the BL module 110 in accordance with the image data outputted from the patch drawing unit 104. In this control, the emission brightness of the BL module 110 is controlled to a higher emission brightness value as the brightness value of the image I (representative value of the brightness or gradation values) is higher, for example. The representative value is a maximum value, a minimum value, an average value, a mode, a median or the like. In concrete terms, the BL control unit 109 can perform the LD control, which individually controls the emission brightness of each light source of the BL module 110 in accordance with the image data outputted from the patch drawing unit 104. For example, in the LD control, the emission brightness of the light source corresponding to a region of the image is controlled such that the emission brightness is higher as the brightness (gradation value) of the image is higher. The BL control unit 109 switches between the LD control ON state and the LD control OFF state in accordance with the user operation using the display apparatus 100 (UI unit 101), or in accordance with the LD control switching request from the control unit 103, for example.

A concrete example of the LD control will be described. In Embodiment 1, the size (area) of the patch image is indicated by ratio (%) with respect to the size (area) of the display surface. In the case where a white patch image (maximum gradation value: 255) is displayed in a black image (minimum gradation value: 0) and the size of the white patch image is 10% (first case), each light source is controlled such that light sources corresponding to the region of the patch image turn ON and light sources corresponding to the region outside the patch image (region other than the patch image) turn OFF. On the other hand, in the case where a white patch image (maximum gradation value: 255) is displayed and the size of the white patch image is 100% (second case). In other words, in the case where a white patch image is displayed on the entire display surface, each light source is controlled such that all light sources turn ON. The method of the LD control is not especially limited, but in Embodiment 1, the diffusion of the light which is emitted from each one of the plurality of light sources is considered when the LD control is performed. In the first case, the light sources corresponding to the region outside the patch image turn OFF, hence a number of light sources that emit light to the region of the patch image is fewer than the second case. Therefore in order to equalize the display brightness of the patch image between the first and the second case, in the first case, the emission brightness of the light sources corresponding to the region of the patch image are controlled to be a higher emission brightness than the second case. In the first case, the emission brightness of the light sources corresponding to the region of the patch image depends on the light diffusion structure of the BL module 110, but is generally controlled to an emission brightness that is about 2 to 3 times that of the second case.

The BL module 110 is a light-emitting unit disposed on the rear surface side of the liquid crystal panel 105, and includes a plurality of light sources. The emission brightness of each light source is controlled by the BL control unit 109. For example, each light source is turned ON or OFF in accordance with the instruction from the BL control unit 109.

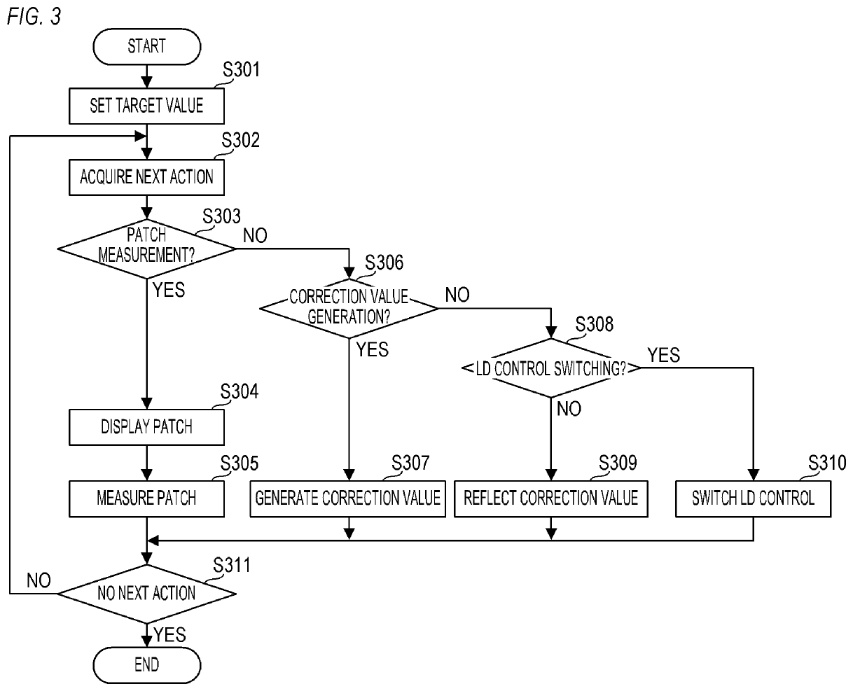

FIG. 3 is a flow chart depicting an example of the processing flow of the display apparatus 100. In the processing flow in FIG. 3, when the LD control is performed, a patch image that is smaller than the display surface of the liquid crystal panel 105 is displayed. Thereby even if the LD control is performed, the temperature change in the region where the patch image is displayed can be reduced, and highly accurate calibration can be performed. When the control unit 103 receives a signal in accordance with the calibration start operation from the UI unit 101, the processing flow in FIG. 3 is started.

In step S301, the control unit 103 outputs the target value of the calibration to the CAL unit 102. In Embodiment 1, it is assumed that, as the target values of the calibration, the target values of the brightness, color gamut, color temperature and gamma of the display apparatus 100 are used. Also the target values of the photometric values (values to be acquired as the photometric values) may be used as the target values of the calibration.

In step S302, the control unit 103 outputs a next processing acquisition request to the CAL unit 102, and acquires information on an action to be executed next from the CAL unit 102. In the N-th (N is a 1 or greater integer) step S302, information indicating the action of which execution number is N is acquired. For example, in the case of using the action list in FIG. 2, information indicating “LD OFF”, of which execution number is 1, is acquired in the first step S302.

In step S303, the control unit 103 determines whether the information (action) acquired from the CAL unit 102 in step S302 is “patch photometry”. Processing advances to step S304 if the acquired information is “patch photometry” or to S306 if not “patch photometry”.

In step S304, the control unit 103 outputs the patch drawing request to the patch drawing unit 104. In step S302, the control unit 103 acquires the color information and the size information from the CAL unit 102 along with the information indicating “patch photometry”. In step S304, the control unit 103 outputs the color information and the size information acquired in step S302 to the patch drawing unit 104 along with the patch drawing request. As a result, a patch image having the gradation values (pixel values, RGB values) indicated by the color information and the size indicated by the size information is generated by the patch drawing unit 104, and this patch image is displayed on the display surface of the liquid crystal panel 105. For example, in the case of the execution number 2 in FIG. 2, a white patch image having RGB values=(255, 255, 255) is displayed on the display surface at 100% size.

In step S305, the control unit 103 outputs a photometric value acquisition request to the photometer communication unit 108 via the photometric value acquisition unit 107. As a result, the photometer communication unit 108 outputs the photometry instruction to the photometer. Then the photometer performs photometry on the patch image displayed in step S304, and outputs the acquired photometric value to the control unit 103 via the photometer communication unit 108 and the photometric value acquisition unit 107.

In step S306, the control unit 103 determines whether the information (action) acquired from the CAL unit 102 in step S302 is “correction value generation”. Processing advances to S307 if the acquired information is “correction value generation”, or to step S308 if not “correction value generation”.

In step S307, the control unit 103 outputs the correction value generation request and the photometric value acquired in step S305 to the CAL unit 102. As a result, the CAL unit 102 generates the correction value for the current step (step corresponding to the current action) from the target value of the calibration and the photometric value. For example, in the case where the step is “color gamut correction”, correction values (e.g., correction values to change the balance of the R value, G value and B value) are generated so that each photometric value of the white patch, red patch, green patch and blue patch becomes closer to the standard value of the color gamut that is specified as the target value. For example, the white patch is a patch image of the RGB values (255, 255, 255), the red patch is a patch image of the RGB values (255, 0, 0), the green patch is a patch image of the RGB values (0, 255, 0), and the blue patch is a patch image of the RGB values (0, 0, 255). In the case where the step is “brightness correction”, the correction values (e.g. correction values to increase/decrease the gain value) are generated so that the photometric value (brightness) of the white patch becomes close to the brightness specified as the target value.

In step S308, the control unit 103 determines whether the information (action) acquired from the CAL unit 102 in step S302 is “LD control switching”. Processing advances to step S310 if the acquired information is “LD control switching” or to step S309 if the acquired information is not “LD control switching” (if the acquired information is “correction value reflection”).

In step S309, the control unit 103 outputs the correction value acquisition request to the CAL unit 102. As a result, the CAL unit 102 outputs the correction values generated in step S307 to the control unit 103, and the control unit 103 reflects the correction values acquired from the CAL unit 102 in the parameters of the display apparatus 100 (parameter correction by calibration). When the parameters are updated (correction values are reflected in the parameters), the transmittance of the liquid crystal panel 105 is corrected or the emission brightness of the BL module 110 is corrected, for example, in accordance with the updated parameters. The image data (gradation values), which is inputted to at least one of the liquid crystal panel 105 and the BL module 110, may be corrected in accordance with the updated parameters.

In step S310, the control unit 103 outputs the LD control switching request to the BL control unit 109. In concrete terms, when the current action is “LD OFF”, the control unit 103 outputs the LD control switching request to the BL control unit 109 so that the execution state of the LD control turns OFF. And when the current action is “LD ON”, the control unit 103 also outputs the LD control switching request to the BL control unit 109 so that the execution state of the LD control turns ON.

In step S311, the control unit 103 inquires to the CAL unit 102 whether there is an action to be executed next. If there is no next action, that is, if all the actions on the action list have been executed, the processing flow in FIG. 3 ends. If there is a next action, processing returns to step S302.

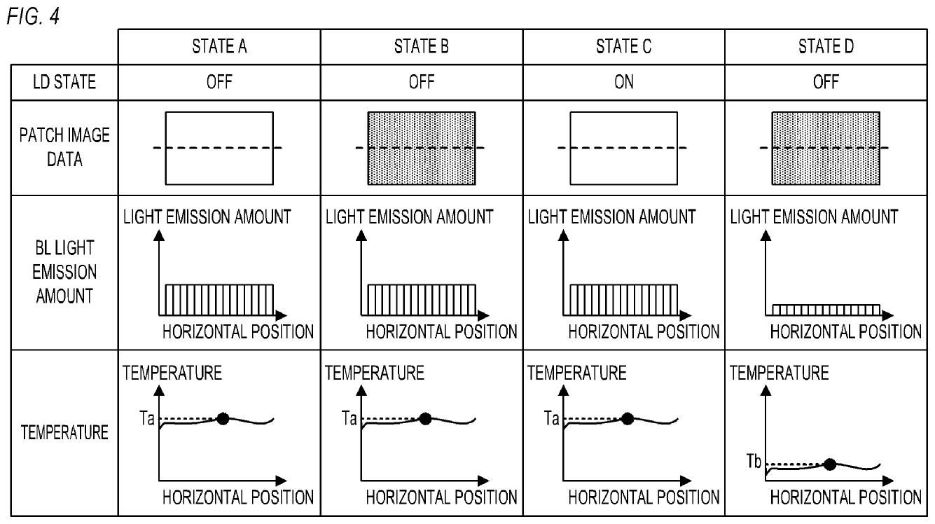

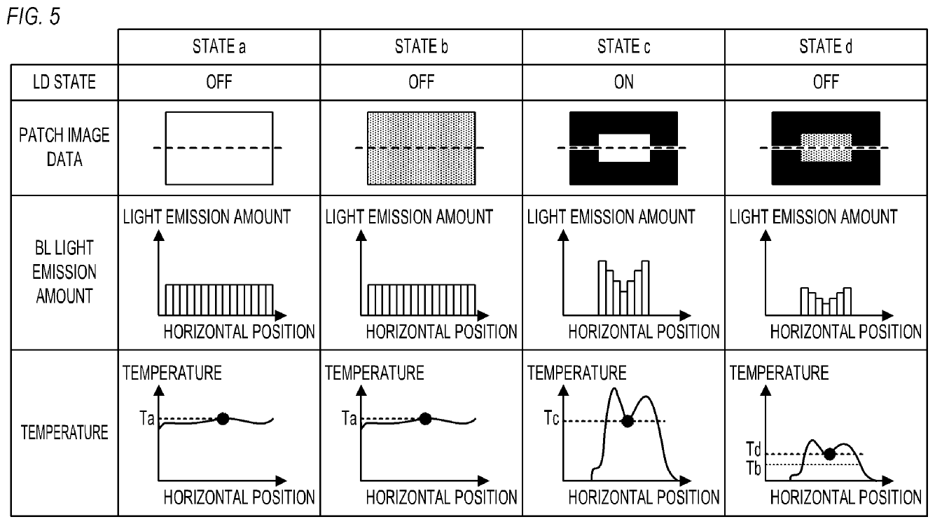

As mentioned above, according to Embodiment 1, a patch image smaller than the display surface of the liquid crystal panel 105 is displayed when the LD control is performed. Thereby even if the LD control is performed, the temperature change in the region where the patch image is displayed is reduced, and highly accurate calibration can be performed. A concrete example of this function and effect (or the principle of this effect) will be described in reference to FIGS. 4 and 5. FIGS. 4 and 5 indicate examples of the execution state of the LD Control, patch image data, distribution of the emission brightness (or light-emitting amount) of the BL module 110, and temperature distribution on the display surface of the liquid crystal panel 105. In FIGS. 4 and 5, the distribution of the emission brightness or the distribution of the temperature indicates the distribution of the values on the broken line drawn in the patch image data, and indicates a plurality of values corresponding to a plurality of positions located at the center of the display surface in the vertical direction (a plurality of positions lined up in the horizontal direction). Here as well, the size (area) of the patch image is indicated by ratio (%) with respect to the size (area) of the display surface. Further, the gradation value (brightness) of the patch image data is indicated by ratio (%) with respect to the maximum gradation value 255.

FIG. 4 is an example (comparative example) in the case where the patch image is always displayed at 100% size. In state A, the execution state of the LD control is OFF, and the gradation value of the patch image is 100%. In state B, the execution state of the LD control is OFF, and the gradation value of the patch image is 50%. And in states A and B, the execution state of the LD control is OFF, hence the distribution of the emission brightness (emission brightness of each light source) of the BL module 110 is fixed regardless the gradation value of the patch image (regardless whether the gradation value of the patch image is 100% or 50%).

In state C, execution state of the LD control is ON, the gradation value of the patch image is 100%, and the distribution of the emission brightness of the BL module 110 is the same as states A and B. In other words, in the case where the gradation value of the patch image is 100% and the size of the patch image is 100%, the temperature change is not generated (or not generated very much) in the region where the patch image is displayed, even if the execution state of the LD control is switched between ON and OFF. However if the gradation value of the patch image is not 100% and the size of the patch image is 100%, a major temperature change is generated in the region where the patch image is displayed when the execution state of the LD control is switched. Further, if the size of the patch image is 100%, a major temperature change is generated in the region where the patch image is displayed in the LD control ON state when the gradation value of the patch image changes.

In state D, the execution state of the LD control is ON, and the gradation value of the patch image is 50%. Since the gradation value of the patch image (gradation value of the entire display surface) is 50%, which is lower than state C (100%), the emission brightness of the BL module 110 drops in general when the states A, B and C change to state D. As a result, the temperature at the center portion of the patch image (center potion of the display surface) changes (drops) from the temperature Ta to the temperature Tb. This temperature change drops the accuracy of calibration.

FIG. 5 is an example (Embodiment 1) in the case where the patch image is displayed at 100% size in the LD control OFF state, and the patch image is displayed at 10% size in the LD control ON state. State a is the same as state A in FIG. 4, and state b is the same as state B in FIG. 4.

In state d, the execution state of the LD control is ON, and the gradation value of the patch image is 50%. Just like state D in FIG. 4, the emission brightness of a plurality of light sources corresponding to the patch image is controlled to be an emission brightness value that is lower than states a and b. However, the emission brightness value of the light sources corresponding to the peripheral portion of the patch image, out of the plurality of light sources corresponding to the patch image, is controlled to be an emission brightness value that is higher than state D in FIG. 4. In concrete terms, when the light sources corresponding to outside the patch image, which is black (gradation value: 0%), turns OFF, the leaked light from the light sources corresponding to outside the patch image to the peripheral portion inside the patch image decreases. Then the emission brightness value of the light sources corresponding to the peripheral portion inside the patch image is controlled to an emission brightness value that is higher than state D in FIG. 4, so that a drop in the display brightness due to the decrease in leaked light is suppressed (or reduced).

By controlling the emission brightness value of the light source corresponding to the peripheral portion of the patch image is controlled to be an emission brightness value that is higher than state D in FIG. 4, the temperature in the center portion of the patch image becomes the temperature Td, which is higher than the temperature Tb in state D and is close to the temperature Ta in state a and b. In other words, even if the execution state of the LD control is switched, a major temperature change is not generated in the region where the patch image is displayed, and highly accurate calibration can be performed.

In state c, the execution state of the LD control is ON, and the gradation value of the patch image is 100%. Just like state d, the emission brightness value of a plurality of light sources corresponding to the peripheral portion of the patch image, out of the plurality of light sources corresponding to the patch image, is controlled to be an emission brightness value that is higher than states a and b. However, the light sources corresponding to outside the patch image, which is black, are turned OFF. Therefore the temperature in the center portion of the patch image becomes the temperature Tc that is close to the temperature Ta. In other words, even if the execution state of the LD control switches or the gradation values of the patch image change in the LD control ON state, a major temperature change is not generated in the region where the patch image is displayed, and highly accurate calibration can be performed.

As described above, according to Embodiment 1, a patch image that is smaller than the display surface is displayed when the LD control is performed. Thereby even if the LD control is performed, the temperature change in the region where the patch image is displayed is reduced, and highly accurate calibration can be performed. Specifically, even if the execution state of the LD control switches or the gradation values of the patch image change in the LD control ON state, the temperature change in the region where the patch image is displayed is reduced, and highly accurate calibration can be performed. This effect is more conspicuous when the mode of the display apparatus 100 is set to a mode to display an HDR image.

In Embodiment 1, an example of displaying the patch image at 10% size in the LD control ON state was described. However, the size of the patch image is not limited to 10%. An appropriate size of the patch image may be determined in advance by measuring the change in the gradation values of the patch image in the LD control ON state, or by measuring the temperature change caused by switching of the execution state of the LD control, while changing the size of the patch image, for example. Then an even more accurate calibration can be performed by further reducing the temperature change in the region where the patch image is displayed. The size of the patch image may or may not be determined for each display apparatus. In the case of a general purpose display apparatus that can execute the LD control, the BL module (light-emitting unit) normally includes 4 or more light sources to improve the in-plane contrast of the display image (image displayed on the display surface). In other words, the size of a region corresponding to one light source on the display surface often becomes about 25% or less. Therefore it is preferable that the size of the patch image in this case is 25% or less. In the case of a display apparatus that supports high image quality display, the BL module normally includes 10 or more light sources. Therefore it is preferable that the size of the patch image is 10% or less. The size of the patch image must be at least the minimum measurement diameter of the photometer. If the size of the patch image is too small, the temperature rises in the case of a white patch image, which may negatively influence the accuracy of calibration, therefore it is preferable that the size of the patch image is 5% or more. As indicated in state C and state D in FIG. 5, it is preferable that the patch image is disposed at the center of the patch image data such that the center of the display surface of the display apparatus matches with the center of the patch image.

In Embodiment 1, an example of displaying the patch image of which size is different between the LD control ON state and the LD control OFF state was described. In concrete terms, an example of displaying a patch image (box pattern) that is smaller in the LD control ON state than in the LD control OFF state (displaying a patch image, or full screen pattern, that is larger in the LD control OFF state than in the LD control ON state) was described. However, in the LD control OFF state, the emission brightness of the BL module is fixed. Therefore in the LD control OFF state, a patch image that is smaller than the case of the LD control ON state may be displayed, or a patch image that is the same size as the case of the LD control ON state may be displayed. If the size of the patch image is the same between the LD control ON state and the LD control OFF state, a decrease in processing load, a decrease in transmission volume of instruction data, for example, can be expected.

Further, in Embodiment 1, the calibration is performed for both the LD control OFF state and the LD control ON state, but calibration in the LD control ON state may be performed only when the set value of the display apparatus 100 is a predetermined set value. For example, in the case where a mode to display the HDR image is set in the display apparatus 100, calibration is performed in both the LD control OFF state and the LD control ON state, and in the case where a mode to display the SDR image is set in the display apparatus 100, calibration is performed only in the LD control OFF state. For example, the calibration is performed in the LD control ON state only when the setting of the display apparatus 100 is: the brightness (maximum display brightness; white brightness) is at least 1,000 cd/m², the color gamut is DCI-P3 or Rec. 2020, and the gamma is HLG or PQ. DCI-P3 is the color gamut conforming to the digital cinema standard specified by Digital Cinema Initiatives. Rec. 2020 is the color gamut conforming to the ITU-R BT. 2020 standard. HLG is the acronym for Hybrid Log Gamma, and PQ is the acronym for Perceptual Quantization, and both conform to the ITU-R BT. 2100 standard.

Further, in Embodiment 1, an example of performing the LD control, to control the emission brightness (emission brightness of the BL module) in accordance with the image data, was described. However, global dimming (GD) control may be performed to control the emission brightness in accordance with the image data. In GD control, the emission brightness of the BL module is uniformly controlled throughout the BL module (light-emitting surface of the BL module) in accordance with the image data. In the case of performing the GD control, the emission brightness of the BL module is changed from the emission brightness in accordance with the image data, and a patch image, that is smaller than the display surface, is displayed on the display surface. At this time, it is preferable that the emission brightness of the BL module is changed from the emission brightness in accordance with the image data by the change amount in accordance with the size of the patch image. In concrete terms, it is preferable that the emission brightness of the BL module is changed from the emission brightness in accordance with the image data by the change amount that is larger as the patch image is smaller. It is also preferable that the emission brightness is changed by increasing the emission brightness. In other words, it is preferable that the emission brightness of the BL module is increased from the emission brightness in accordance with the image data by the increase amount that is larger as the patch image is smaller. Thereby even if the execution state of the GD control is switched between the ON state and the OFF state, or even if the gradation value of the patch image is changed in the GD control ON state, the temperature change in the region where the patch image is displayed is reduced, and highly accurate calibration can be performed. The GD control ON state is a state where the GD control is performed, and the GD control OFF state is a state where the GD control is not performed.

In the GD control ON state, the transmittance of the liquid crystal panel may be changed from the transmittance in accordance with the image data, so as to minimize the change of the display brightness caused by changing the emission brightness of the BL module from the emission brightness in accordance with the image data. For example, in the case of increasing the emission brightness of the BL module from the emission brightness in accordance with the image data, the transmittance of the liquid crystal panel may be decreased from the transmittance in accordance with the image data. In concrete terms, in the case of increasing the emission brightness value of the BL module to a value that is M times (M is a real number) of the emission brightness value in accordance with the image data, the transmittance of the liquid crystal panel may be decreased to a value that is 1/M times of the transmittance in accordance with the image data.

### Embodiment 2

Embodiment 2 of the disclosure will be described next. In Embodiment 2, the patch image is displayed at a size in accordance with the gradation value of the patch image. Thereby the temperature change in the region where the patch image is displayed is further reduced, and an even more accurate calibration can be performed. In the following, aspects (e.g., configuration, processing) different from Embodiment 1 will be described in detail, and unnecessary redundant description will be omitted.

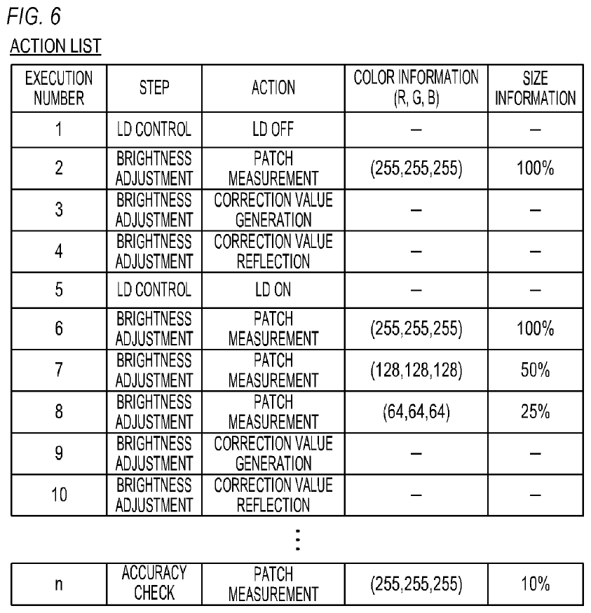

In Embodiment 2, it is assumed that the action list indicated in FIG. 6 is used. In the action list in FIG. 6, the size information (size of the patch image) in accordance with the color information (gradation value of the patch image) is defined. For example, in the case of the execution number 6, the color information indicates RGB values (255, 255, 255) and the size information indicates 100%. In the case of the execution number 7, the color information indicates RGB values (128, 128, 128) and the size information indicates 50%. In the case of the execution number 8, the color information indicates RGB values (64, 64, 64) and the size information indicates 25%. In other words, a smaller size is defined as the gradation value of the patch image is smaller. As a result, the patch image is displayed in a smaller size as the gradation value of the patch image is smaller. In the case where the gradation value of the patch image is small in the LD control ON state, a small patch image is displayed, so that the light source corresponding to the patch image (light source of the BL module 110) is brightly lit, and the temperature in the center portion of the patch image becomes closer to the temperature in the LD control OFF state. In the case where the gradation value of the patch image is large in the LD control ON state, a large patch image is displayed, so that the temperature in the center portion of the patch image becomes closer to the temperature in the LD control OFF state.

As described above, according to Embodiment 2, the patch image is displayed in the size in accordance with the gradation value of the patch image, specifically in the size that is smaller as the gradation value of the patch image is smaller. Thereby the temperature change in the region where the patch image is displayed can be further reduced, and an even more accurate calibration can be performed. The patch image may be displayed in the size in accordance with the gradation value of the patch image only in the LD control ON state, or the patch image may be displayed in the size in accordance with the gradation value of the patch image regardless the execution state of the LD control. Further, the patch image may be displayed in a predetermined size that does not depend on the gradation value of the patch image in the LD control OFF state.

Each composing element of Embodiments 1 and 2 (including modifications) may or may not be a standalone hardware. The functions of at least 2 blocks may be implemented by common hardware. Each of a plurality of functions of one block may be implemented by standalone hardware respectively. At least 2 functions of one block may be implemented by common hardware. Each block may or may not be implemented by hardware. For example, an apparatus may include a processor and a memory storing a control program. Then the functions of at least a part of the blocks of the apparatus may be implemented by the processor reading the control program from the memory and executing the control program.

Embodiments 1 and 2 (including modifications) are merely examples, and configurations implemented by appropriately modifying or changing the configurations of Embodiments 1 and 2 within the scope of the essence of the disclosure are also included in the disclosure. Configurations implemented by appropriately combining the configurations of Embodiments 1 and 2 are also included in the disclosure.

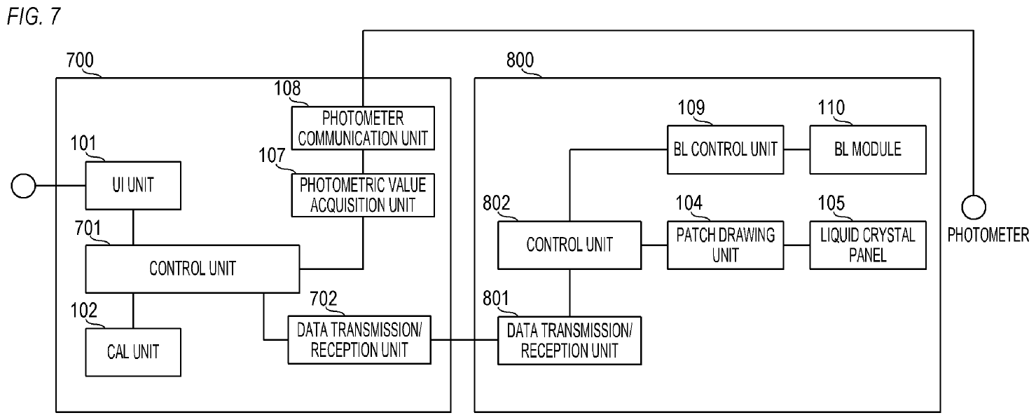

The display apparatus may be controller by an external control apparatus (e.g., personal computer), for example. FIG. 7 is a block diagram depicting a configuration example of a display apparatus 800 and a control apparatus 700 for controlling the display apparatus 800. The control apparatus 700 and the display apparatus 800 are connected so as to communicate with each other. The communication between the control apparatus 700 and the display apparatus 800 may be a cable connection or wireless communication. In FIG. 7, a block the same as the block in FIG. 1 is denoted with a same reference sign.

The control apparatus 700 includes the UI unit 101, the CAL unit 102, the photometric value acquisition unit 107, the photometer communication unit 108, a control unit 701 and a data transmission/reception unit 702. The control unit 701 controls the control apparatus 700 and the display apparatus 800. As with the control unit 103, the control unit 701 includes at least a memory and at least a processor (not shown). The memory contains a program or instructions. The processor is a programmable device, a processor, or a CPU that, by executing the program or instructions in the memory, functions as the various units as described above. The data transmission/reception unit 702 transmits/receives various data to/from the display apparatus 800 (data transmission/reception unit 802). The display apparatus 800 includes the patch drawing unit 104, the liquid crystal panel 105, the BL control unit 109, the BL module 110, a control unit 801 and a data transmission/reception unit 802. The control unit 801 controls the display apparatus 800. As with the control unit 103, the control unit 801 includes at least a memory and at least a processor (not shown). The memory contains a program or instructions. The processor is a programmable device, a processor, or a CPU that, by executing the program or instructions in the memory, functions as the various units as described above. The data transmission/reception unit 802 transmits/receives various data to/from the control apparatus 700 (data transmission/reception unit 702).

The control unit 701 of the control apparatus 700 performs processing similar to the control unit 103 in FIG. 1. The control unit 103 in FIG. 1 directly controls the patch drawing unit 104 and the BL control unit 109, but the control unit 701 in FIG. 7 controls the patch drawing unit 104 and the BL control unit 109 via the data transmission/reception unit 702, the data transmission/reception unit 802 and the control unit 801.

In the example in FIG. 7, the control apparatus 700 performs acquisition of the photometric value, calibration, switching of the execution state of the LD control, display control of the patch image and the like, but the disclosure is not limited to this. For example, at least a part of the acquisition of the photometric value, calibration, switching of the execution state of the LD control unit and the like may be performed by the display apparatus 800 or by another apparatus that is different from the control apparatus 700 and the display apparatus 800. In the case where an apparatus that is different from the control apparatus 700 switches the execution state of the LD control, for example, the control apparatus 700 may acquire information on the execution state of the LD control from the outside, and perform the display control of the patch image based on this information.

According to this disclosure, if the emission brightness of the light-emitting unit is controlled in accordance with the image data, highly accurate calibration can be performed.

### Other Embodiments

Embodiment(s) of the disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of units of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2019-181450, filed on Oct. 1, 2019, which is hereby incorporated by reference herein in its entirety.

What is claimed is:

1. A control apparatus for controlling a display apparatus including a light-emitting module and a display panel configured to display an image based on image data on a display surface by modulating light emitted from the light-emitting module, the control apparatus comprising:
at least one memory containing instructions; and
at least one processor which, by executing the instructions, functions as:
a control unit configured to control the display apparatus so that a patch image for calibration of the display apparatus is displayed on the display surface,
wherein in a case where an emission brightness of the light-emitting module is controlled in accordance with the image data, the control unit controls the display apparatus so that a patch image that is smaller than the display surface is displayed on the display surface.

2. The control apparatus according to claim 1,
wherein the light-emitting module includes a plurality of light sources, and
the case where the emission brightness of the light-emitting module is controlled in accordance with the image data is a case where an emission brightness of each of the plurality of light sources is individually controlled in accordance with the image data.

3. The control apparatus according to claim 1, wherein a size of the patch image is not more than 25% of a size of the display surface.

4. The control apparatus according to claim 3, wherein a size of the patch image is not more than 10% of a size of the display surface.

5. The control apparatus according to claim 1, wherein a size of the patch image is not less than 5% of a size of the display surface.

6. The control apparatus according to claim 1, wherein the patch image is displayed in an image that is darker than the patch image.

7. The control apparatus according to claim 1, wherein the control unit controls the display apparatus so that the patch image is displayed on the display surface in a case where a brightness of the display apparatus is set to a brightness value that is not less than 1,000 cd/m².

8. The control apparatus according to claim 7, wherein the control unit controls the display apparatus so that the patch image is displayed on the display surface in the case where the brightness of the display apparatus is set to the brightness value that is not less than 1,000 cd/m², a color gamut of the display apparatus is set to DCI-P3 or Rec. 2020, and a gamma of the display apparatus is set to HLG or PQ.

9. The control apparatus according to claim 1, wherein the control unit controls the display apparatus so that a size of the patch image that is displayed on the display surface is different between the case where the emission brightness of the light-emitting module is controlled in accordance with the image data, and a case where the emission brightness of the light-emitting module is not controlled in accordance with the image data.

10. The control apparatus according to claim 9, wherein in the case where the emission brightness of the light-emitting module is controlled in accordance with the image data, the control unit controls the display apparatus so that the size of the patch image that is displayed on the display surface is smaller than in the case where the emission brightness of the light-emitting module is not controlled in accordance with the image data.

11. The control apparatus according to claim 1, wherein the case where the emission brightness of the light-emitting module is controlled in accordance with the image data is a case where the emission brightness of the light-emitting module is uniformly controlled throughout the light-emitting module in accordance with the image data.

12. The control apparatus according to claim 1, wherein the control unit controls the display apparatus so that the patch image is displayed on the display surface in a size in accordance with a gradation value of the patch image.

13. The control apparatus according to claim 12, wherein the control unit controls the display apparatus so that the patch image is displayed in a smaller size on the display surface as the gradation value of the patch image is smaller.

14. The control apparatus according to claim 1, wherein the at least one processor, by executing the instructions, further functions as:
an acquisition unit configured to acquire a measured value of light from a region on the display surface where the patch image is displayed, and
a calibration unit configured to perform the calibration of the display apparatus using the measured value acquired by the acquisition unit.

15. The control apparatus according to claim 1, wherein the at least one processor, by executing the instructions, further functions as a switching unit configured to switch between presence and absence of control of the emission brightness of the light-emitting module in accordance with the image data.

16. A display apparatus including a light-emitting module and a display panel configured to display an image based on image data on a display surface by modulating light emitted from the light-emitting module, the display apparatus comprising:
at least one memory containing instructions; and
at least one processor which, by executing the instructions, functions as:
a control unit configured to control the display apparatus so that a patch image for calibration of the display apparatus is displayed on the display surface,
wherein in a case where an emission brightness of the light-emitting module is controlled in accordance with the image data, the control unit controls the display apparatus so that a patch image that is smaller than the display surface is displayed on the display surface.

17. A control method for controlling a display apparatus including a light-emitting module and a display panel configured to display an image based on image data on a display surface by modulating light emitted from the light-emitting module, the control method comprising:
acquiring the image data; and
controlling the display apparatus so that a patch image for calibration of the display apparatus is displayed on the display surface,
wherein in a case where an emission brightness of the light-emitting module is controlled in accordance with the image data, in the controlling, the display apparatus is controlled so that a patch image that is smaller than the display surface is displayed on the display surface.

18. A non-transitory computer readable medium that stores a program, wherein the program causes a computer to execute a control method for controlling a display apparatus including a light-emitting module and a display panel configured to display an image based on image data on a display surface by modulating light emitted from the light-emitting module, the control method including:
acquiring the image data; and
controlling the display apparatus so that a patch image for calibration of the display apparatus is displayed on the display surface,
wherein in a case where an emission brightness of the light-emitting module is controlled in accordance with the image data, in the controlling, the display apparatus is controlled so that a patch image that is smaller than the display surface is displayed on the display surface.
